(19) United States
(12) Patent Application Publication
(10) Pub. No.: US 2020/0300558 A1
(43) Pub. Date: Sep. 24, 2020

(54) THERMAL BARRIER AND INNER HEAT-STORAGE ELEMENT

(71) Applicant: Hutchinson, Paris (FR)

(72) Inventors: Fabrice Chopard, Saint Martin d'Heres (FR); Cédric Huillet, Montargis (FR); Fanny Geffray, Rennes (FR)

(73) Assignee: Hutchinson, Paris (FR)

(21) Appl. No.: 16/083,737

(22) PCT Filed: Mar. 9, 2017
(86) PCT No.: PCT/FR2017/050539

§ 371 Date: Sep. 10, 2018

(30) Foreign Application Priority Data
Mar. 11, 2016 (FR) 1652071

(51) Int. Cl. F28D 20/02

(52) U.S. Cl. CPC F28D 20/021; B60H 1/00492; F28D 20/023

(57) ABSTRACT

The invention relates to thermal management aimed at maintaining the temperature inside a space. The proposed assembly includes the space and a device arranged around same, placed in an outdoor environment exposed to a non-constant temperature and including at least one thermally insulating element inserted between the inner space and the outdoor environment and, from the inside towards the outside: an inner heat-storage element made of PCM material and an outer thermal barrier containing several PCMs. The invention also includes a cooling unit for provisionally providing, in the inner space, a charge fluid, at least at a temperature that is different from those of the temperature to be maintained, in heat transfer with the PCM of the inner element, so as to store thermal energy.

This invention relates to the field of thermal management.

The invention particularly relates to an assembly comprising a thermal management device for promoting a maintenance of a temperature in a predetermined range in an inner space and/or vis-à-vis an element arranged therein, while the device surrounds said inner space and is placed in an outdoor environment exposed to a non-constant temperature.

In this context, the invention particularly relates to refrigeration plants, thermal energy storage and return units, whose inner space is to be thermally maintained, vehicles in which the temperature of the passenger compartment or an adjoining storage zone also has to be maintained, or buildings elements located in a certain outdoor environment.

In fact, it is designed such that in order to ensure the thermal management of an inner space and/or an element arranged therein, it may be useful both to be able to insulate said space and/or its contents from the outdoor environment, and more accurately to manage the temperature within operating margins, and to delay the propagation of a disruptive thermal flow towards this space.

It is in this context that the invention proposes that said assembly should comprise:
said internal space to be thermally managed,
said device arranged around and placed in an outdoor environment exposed to a non-constant temperature, the device comprising at least one thermally insulating element interposed between the inner space and the outdoor environment, and, from the inside, where said inner space is located and/or the element arranged therein, towards the outside where said outdoor environment is located:
   an inner heat-storage element containing at least one PCM material having a phase transition temperature between liquid and solid, which is different from those included in said predetermined temperature range and/or substantially equal to that of a charge fluid,
   and an outer thermal barrier containing at least one PCM material which stores or transfers thermal energy by phase transitions between liquid and solid, and which has at least a phase transition temperature of between −50° C. and 60° C., in order to brake the thermal action of the outdoor environment by phase transitions,
and means for temporarily supplying said charge fluid in said inner space at least at a temperature different from that in said predetermined temperature range during heat transfer with said at least one PCM material such that it then stores thermal energy.

The insulating materials make it possible to limit heat transfer between the inside and the outside.

Through heat transfer, a PCM will make it possible:
if it acts as a thermal barrier, to slow down the propagation of a hot or cold front by phase transition;
if it acts as a thermal storage means, to store thermal energy that will be released later to a structure and/or a fluid with which it will be in contact.

For example, the inside of a building to be passively preserved from excessive outdoor heat, while aiming at an indoor comfort temperature, may thus be less hot during the day, due to the effect of the thermal barrier and the insulation, and less cold at night, again due to the effect of the insulation and the thermal storage that were able to occur during the day.

As proposed above, combining a thermal barrier and a thermal storage therefore makes a lot of sense. This will be all the more so, even if this principle is complicated when it is necessary to thermally manage a space in which the temperature can vary and must be installed in a harsh environment, with temperature gradients of up to several dozens of degrees Celsius.

In order for both the outer thermal barrier and the inner thermal storage means to effectively perform their differentiated roles, it is advisable that the heat-insulating element be placed between them.

To carry out the thermal insulation and a favourable efficiency/weight ratio, this insulating element should contain a porous material, and preferably a nanoporous material.

For this purpose and/or for potentially mechanical purposes, the invention furthermore recommends that this heat-insulating element be arranged in one (or a series of) airtight wrapping(s), to define at least one vacuum insulation panel, VIP. This may also usefully be the case for the outer thermal barrier and/or the inner thermal storage means.

In order to enhance overall thermal efficiency and a relatively simple and easy-to-implement manufacture, this invention recommends that at least one of the inner thermal storage elements and the outer thermal barrier comprise a plurality of PCM materials having phase transition temperatures that are different from each other.

Thus, it will be possible to stage the external slowdown of the heat flows involved and/or the inner thermal storage.

These PCM materials can be arranged in several layers, or be preferably dispersed in a matrix.

For the overall performance of the thermal storage means, this invention furthermore recommends that the or at least one of the phase transition temperatures of the PCM material(s) of the inner heat-storage element be:
higher than the temperatures in said predetermined temperature range to be maintained, if the temperature of the charge fluid in said inner space is higher than said predetermined temperature range to be maintained,
or lower than the temperatures in said predetermined temperature range to be maintained, if the temperature of the charge fluid in said inner space is lower than said predetermined temperature range to be maintained.

Thus, it will be possible to accumulate an amount of energy in an inner wall at a temperature level higher than or equal to (when hot) or, lower or equal (when cold) to those of said predetermined temperature range to be maintained. A surface element will maintain the space to be protected at such a temperature higher in hot or lower in cold conditions for a longer time. In the course of time, the differential temperature of the inner wall will be delayed by the same amount of time, which will preserve the heat-storage feature in hot or that of the refrigerating enclosure in cold conditions within the temperature range concerned.

In particular, provision will be made in this context such that, said inner heat-storage element containing several PCM materials, should:
have different liquid and solid phase transition temperatures ranging substantially from the highest temperature in said predetermined temperature range to the temperature of the charge fluid in said inner space, if the temperature of the charge fluid in said inner space is less than said predetermined temperature range to be maintained,
or have different liquid and solid phase transition temperatures ranging substantially from the lowest temperature in said predetermined temperature range to the temperature of the charge fluid in said inner space, if the temperature of the charge fluid in said inner space is higher than said predetermined temperature range to be maintained,

In this way, the temperature ranges conducive to the thermal efficiency of this inner heat-storage element will be optimized.

In some typical applications, it is particularly thermal management in a hot outdoor environment (typically more than 25° C. to 30° C.) that might have to be achieved. In this context, it is advisable:
that said inner heat-storage element containing several PCM materials, that the latter have different liquid and solid phase transition temperatures ranging substantially from the highest temperature in said predetermined temperature range to the temperature of the charge fluid in said inner space, if the temperature of the charge fluid in said inner space is lower than said predetermined temperature range to be maintained,
and that the outer thermal barrier contains a plurality of PCM materials having phase transition temperatures greater than or equal to that of the PCM materials of said inner heat-storage element.

Thus, the temperature ranges conducive to the thermal efficiency of the inner heat-storage element will once more be optimized.

To equally aim at optimizing the thermal efficiency of the outer thermal barrier, it is recommended:
that said inner heat-storage element contains a plurality of PCM materials having different phase transition temperatures, ranging, within a first temperature range which is relatively low, between a low temperature and a first higher temperature (T1);
that the outer thermal barrier contains a plurality of PCM materials having different phase transition temperatures, ranging, within a second temperature range higher than the first temperature range, between a second temperature (T2) and a higher temperature;
and that said first and second temperatures (T1, T2) are identical, at nearly 5° C.

The thermal management will thus be refined.

To the best of the knowledge of the inventors, there are no industrial uses of the foregoing as at the day of filing.

In terms of preferred applications, a first of these is therefore aimed at a cold preservation, with a fluid supplying means for supplying a charge fluid comprising a cooling unit.

Thus, the supply of the charge fluid in a cold environment will be managed with confidence.

Same advantage if the inner space comprises a passenger compartment of the vehicle or an adjoining storage zone of the vehicle and if the means for supplying charge fluid comprise means for air conditioning from which said fluid flows, and means of selectively communicating between said fluid and said inner space, depending on the temperature.

This is still a comparable situation for a part of a building constructed and located in an outdoor environment and including said assembly where:
at least one room will then correspond to said inner space, surrounded by a wall provided with said thermal management device,
   and wherein the fluid supplying means will comprise means, such as aeration means, like doors and windows, to create at least one natural convection in said inner space in contact with the inner heat-storage element.

This situation is equally comparable with a unit for storing and subsequently releasing thermal energy, on an on-board system, such as a vehicle or a ship (cruise ship, container ship, etc.), said unit then comprising the aforesaid assembly, where the charge fluid will correspond to the liquid of a forced liquid circulation circuit, such as an oil circuit, communicating with said inner space.

An engine oil heating system could thus be equipped.

Yet another comparable advantage to be expected on a vehicle comprising the aforementioned assembly, where:
the inner space will then correspond to an inner part of an engine adapted to move the vehicle of which a wall will in this case be at least locally provided with said thermal management device,
and the fluid supplying means comprise functional members of the engine disposed in said inner part of an engine, such as a turbocharger, a manifold or an injection pump.

A shield may encapsulate such a engine member (or even a casing) in which engine fluids (especially oil) will pass, with a view to preserving the temperature of these bodies or part of the engine when parking a vehicle, to enable a start from hotter elements than it would be without protection. The accumulation of energy in the storage layer will typically be at the surface temperature of these organs.

In terms of the operating mode, there is furthermore provision that the thermal management of the inner space, or of the element disposed therein, be carried out as follows:
the above-mentioned temperature range of said inner space, or of the element disposed therein, to be maintained is determined,
the thermal management device is made and disposed with at least one heat-insulating element interposed between the inner space and the aforementioned outdoor environment, and, from the inside, where said inner space and/or the element which is disposed therein, is located towards the outside:
   an inner heat-storage element containing at least one PCM material having a phase transition temperature between liquid and solid, which is different from those included in said predetermined temperature range and/or substantially equal to that of a charge fluid,
      and an outer thermal barrier containing at least one PCM material which stores or transfers thermal energy by phase transitions between liquid and solid, and which has at least a phase transition temperature of between −50° C. and 60° C., in order to brake the thermal action of the outdoor environment by phase transitions,
the outer thermal barrier of the device is placed in heat transfer with the outdoor environment, whose temperature ranges between −50° C. and 60° C., and the PCM material(s) and is then allowed to be stored or the thermal energy is transferred depending on said temperature, and said at least one PCM material of the inner heat-storage element is furthermore placed in heat transfer with the inner space, or with the element disposed therein,
and, at certain times, said charge fluid is temporarily brought into said inner space at least at a temperature different from that in said predetermined temperature range, in heat transfer with said at least one PCM material, such that it then stores thermal energy.

### BRIEF DESCRIPTION OF THE DRAWINGS

The invention will, if necessary, be better understood and other details, characteristics and advantages of the invention will become apparent on reading the following description given as a non-exhaustive example and with reference to the accompanying drawings in which:

FIG. 1 diagrammatically shows a refrigerated container (referenced as 11) with thermally managed wall that is found in situation and detailed in FIG. 2;

FIG. 3 shows an alternative to scattered PCM;

FIGS. 4-7 and 9 show other applications of the management device proposed here;

FIG. 8 details a possible embodiment of the storage of the solution of FIG. 7;

and FIGS. 10-11 are two possible embodiments in the form of VIP panels of all the PCM and thermal insulator materials of wall 11 mentioned above.

### DETAILED DESCRIPTION

It should be made clear that FIGS. 2,3 and 5-8 show only a half section. They must be understood as implying that the wall 11 shown on the left of the space 9 is to be reproduced on the right, or even on all sides, always from the inside 9 to the outside 7: the inner heat-storage element 13a then the thermal barrier 13b.

For any intent and purpose, it is furthermore confirmed at this stage that a phase change material—or PCM—refers to a material capable of changing physical state, between liquid and solid, in a restricted temperature range of between −50° C. and 60° C. Heat transfer can be achieved by using its Latent Heat (LH): the material can then store or transfer energy by a simple phase transition, while maintaining a substantially constant temperature, that of the phase transition.

The thermally insulating material(s) associated with the PCM(s) may be a “simple” insulator such as glass wool, but a foam will certainly be preferred, for example polyurethane or polyisocyanurate, or even more preferably a porous or even nanoporous thermally insulating material disposed in a vacuum envelope, to define at least one insulating panel, VIP.

“VIP” means a structure under “controlled atmosphere”, that is to say either filled with a gas having a thermal conductivity lower than that of the ambient air (26 mW/mK), or in “depression”, therefore under a pressure lower than the ambient pressure (thus <10⁵ Pa). Pressure of between 10⁻² Pa and 10⁴ Pa in the enclosure may be particularly suitable. The enclosure may contain at least one heat-insulating material generally porous (pore sizes less than 1 micron). In this case, ensuring the efficiency of the thermal management will be further improved, and even the overall weight decreased compared to another insulator. Typically, VIP panels (vacuum insulating panel, VIP) are thermal insulators where cores made of porous material, for example silica gel or silicic acid powder (SiO2), are pressed into a plate and each surrounded, partial air vacuum, a gas-tight wrapping foil, for example plastic and/or roll-formed aluminium. The resulting vacuum typically lowers the thermal conductivity to less than about 0.01/0.020 W/m·K under the conditions of use. An insulation efficiency 3 to 10 times higher than that of more conventional insulating materials is thus obtained.

“Porous” means a material having interstices allowing the passage of air. Open cell porous materials therefore include foams but also fibrous materials (such as glass wool or rock wool). The passage interstices that may be described as pores have sizes of less than 1 or 2 mm so as to guarantee good thermal insulation, and preferably less than 1 micron, and preferentially still less than 10⁻⁸ m (nanoporous structure), particularly for questions of ageing stability and therefore possible lower depression rate in the VIP envelope.

“Deformable” is a structure that can be deformed, for example bent, by hand. And “sealable” relates to a weldable connection, in particular heat-sealable, or even solderable, particularly with sheets or films (finer).

Having clarified this, only the case of a few examples of preferred applications of the inventive concept presented above will be treated in what follows.

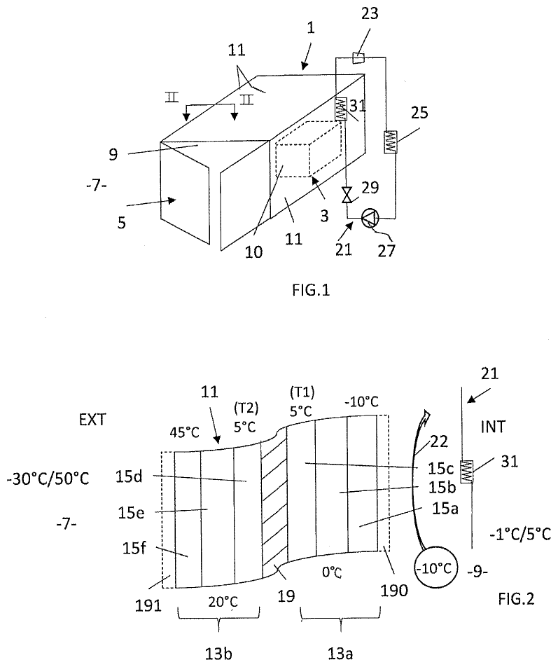

First of all, on FIG. 1 is a refrigerated container 1 comprising a box 3 provided with a movable door 5 that helps insulate at will from the outside 7 (EXT) the closed inner space 9 (INT) of the box or to have access to it with the door open.

Since the outdoor environment 7 is exposed to a non-constant ambient temperature, a transport of thermally sensitive elements or goods, such as foodstuffs or medicines, may be provided in the refrigerated container 1.

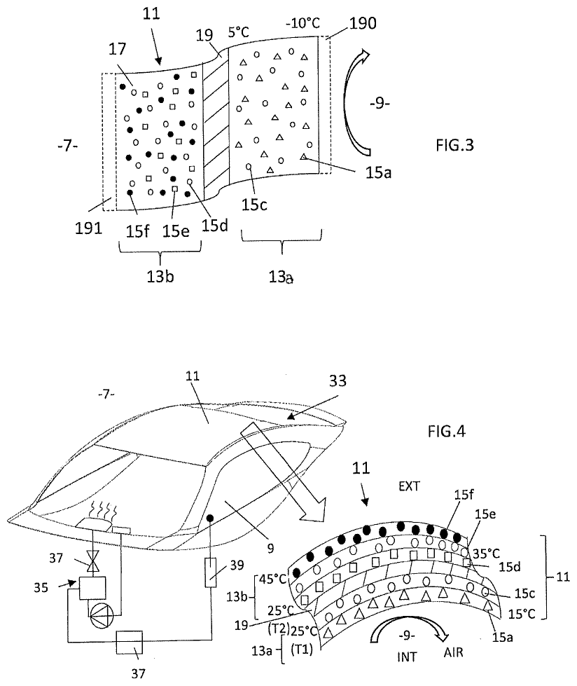

All or part of the wall 11 of the box 3 and/or the door 5 can be formed as follows, with reference to FIGS. 2, 3, with the understanding that the layers mentioned below could be interposed between two walls, respectively outer and inner walls, of the box structure, such as a metal wall and the other plastic. Heat transfers with the zones referenced as 7 and 9 could then be carried out at least partially with these walls, each of which then defines a thermal management device.

However, in the two cases of FIGS. 2 and 3, the constitution of said wall 11 will be helpful for the maintenance of a temperature expected in a predetermined range in the inner space 9 and/or with respect to said elements 10.

Let us consider that we aim at a temperature between −1° C. and 5° C. in the inner space 9 and/or wall of the element 10 then stored in it.

To ensure the expected thermal management, the wall 11 of the box and/or the door comprises from the outside 7 (EXT) to the inside 9 (INT):
an inner heat-storage element 13a containing at least one PCM material (here three 15a, 15b, 15c) having (at least for some) a phase transition temperature between liquid and solid, which is different from those included in said predetermined temperature range (thus out from −1° C. to 5° C. in the example) and/or which is substantially equal to that of a charge fluid 22 temporarily arriving at a lower temperature (−10° C. in the example), a temperature difference being necessary to store the energy,
and an outer thermal barrier 13b containing at least one PCM material (here three 15d, 15e, 15f) storing or releasing heat energy by between liquid and solid, and having one or more phase transition temperature(s) (Tc) of between −50° C. and 60° C.,
and at least one thermal insulating element 19.

If they are multiple, the PCM materials will have different phase transition temperatures from each other, on the barrier side 13b; same for heat-storage element side 13a, although there could however be only one PCM material per side (and possibly only one layer of material, such as those in 15a, 15d).

Via its PCM materials 15d, 15e, 15f the outer thermal barrier 13b will gradually be able to brake the thermal action of the outdoor environment, by successive phase transition temperatures of the PCM, the PCM(s) of the inner element 13a ensuring a thermal storage by heat transfer with the inner space and/or with the element 10, or even with said inner plastic lining wall.

The phase transition temperature of the outermost PCM of the barrier 13b, here 15f, is greater than that of the innermost PCM with respect to the space 9, here the PCM 15d, the same for the inner element 13a, as indicated in the figure.

In the version of FIG. 2, at least the outer thermal barrier 13b, here also the inner thermal storage element 13a, comprises several layers of materials each containing (at least) a PCM material.

For a truly progressive barrier effect, provision can be made such that the layered PCM materials have phase transition temperatures that increase from the first innermost layer (PCM 15a or 15d) to the final outermost layer (PCM 15c or 15f).

A solution to dispersed PCM in a porous and flexible matrix (particularly elastomer-based) could however be preferred, because it is, a priori more industrial.

Moreover, in the version of FIG. 3, at least the outer thermal barrier 13b comprises several PCM materials 15d, 15e, 15f, having different phase transition temperatures which are dispersed in a common matrix 17. This dispersion solution can be applied to the case of FIG. 2, as to those which follow and which correspond to the diagrams of FIG. 4 and following.

Preferably, to clearly differentiate the operating procedures of the zones 13a and 13b, it is advised that at least the identified thermally insulating layer 19 be disposed between the thermal barrier 13b and the inner thermal storage element 13a. One or more thermally insulating layers 190, 191 could also then be provided on the inside and/or outside of the wall 11. This is applicable in all the applications envisaged here (FIGS. 4 to 11).

In order to explain the operating procedure of a wall 11 placed in the context of a refrigerating system, as in FIG. 1, let us take the structural example of FIG. 2 with the understanding that thermal energy storage by the PCM(s) of the inner element 13a may be produced by means (here referenced as 21 or 23) of a temporary supply, in said inner space 9, a charge fluid 22, at least at a different temperature from those in said predetermined temperature range.

In this application, it will preferably be a cooling unit 21 provided to temporarily cool the atmosphere of the space 9.

Traditionally and as illustrated in FIG. 1, this cooling unit 21 comprises, in a closed circuit, a compressor 23, a condenser 25, a pump 27, an expansion valve 29 and an evaporator 31 in which, within the space 9, the air that is thus cooled passes. The production of cold is carried out at the level of the evaporator by evaporation of the refrigerant (for example glycol water) which passes through the circuit and which cools the air by capturing its calories.

Inside, it will be preferred that the PCM material(s) of the element 13a, be involved in heat transfer with the atmosphere 9 or the element 10 so that the or each phase transition temperature is less than or equal to the temperatures in said predetermined temperature range to be maintained (between −1° C. and 5° C. in the example) if, as in the cooling application in question, the temperature of the fluid charge in said inner space 9 (−15° C. in the example) is less than said predetermined temperature range to be maintained.

Thus, by temporarily operating this cooling unit 21, typically at night or just for a few hours, preferably when the outside temperature is lowest, it will be possible for example to bring the temperature in the space 9 to −15° C., and therefore crystallize the PCM 15a, 15b, 15c in the following situation: For example, let us consider that the PCM materials 15f, 15e, 15d of the successive layers change from a liquid state to a solid (crystallized) state respectively below 45° C., 20° C. and 5° C., a rise to these respective temperatures making them individually switch from solid to liquid. Same situations at lower temperatures, respectively 5° C., 0° C. and −10° C., for PCM 15c, 15b, 15a.

For the PCM material (s) of the outer thermal barrier (b) (b) to change from a liquid state to a solid (crystallized) state after liquefaction, the outdoor environment will be used.

When using the box in the diurnal phase, for instance when the door 5 is periodically open and closed while the cooling unit 21 is turned off, the thermal energy released by the PCM 15d, 15e (because the temperature in the space 9 rises then towards 0° C. for example) helps to maintain this temperature between −1° C. and 5° C., this passively so, without any energy supply resulting for example from restarting the cooling unit 21.

At the same time that these energy storage and return occur, the wall 11 is also typically exposed to the outdoor temperatures of the environment 7.

Thus, disposed around the inner space 9, in contact with the outdoor atmosphere 7, the thermal barrier 13b will undergo the influence of a temperature that will typically evolve between −50° C. (cold countries) and 60° C. (warm countries).

In the example above, the hypothesis is thermal management in hot countries. In cold countries, it is against an excessive cold in the space that it would have been necessary to fight via the PCM outdoor materials 15d, 15e, 15f (whose phase transition temperatures would have been lower) and thermal insulation 19.

Suppose the night temperature goes down to 4° C.

The PCM outdoor materials 15d, 15e, 15f are all then in the solid (crystallized) state. Thus, following a hot day, these materials are recharged.

During the day the temperature rises again and even exceeds 45° C. The PCM outdoor materials 15d, 15e, 15f then gradually liquefy and thus charge themselves with heat energy, thereby delaying the action of the thermal insulation 19 and all the more so the thermal impact on the space 9.

Thermal insulation 19 will preferably be a super-insulator, such as a porous aerogel.

For the potential energy storage in the PCM materials of the inner storage element 13a to be maximum, these materials have different phase transition temperatures, between liquid and solid temperatures, ranging substantially from the temperature of the charge fluid in said inner space (here −10° C.) to the highest temperature in said predetermined temperature range (here 5° C.), with the understanding that the temperature of the charge fluid in the space 1 here is lower than said predetermined temperature range to be maintained (−1° C. to 5° C.).

And for a maximum efficiency of the insulator 19, these same PCM materials 15c, 15a or even 15b at different phase transition temperatures, ranging, in a first range of relatively low temperatures, from a low temperature (here −10° C., temperature below the target operationally functional range of the refrigeration system presented) to a first higher temperature (T1=5° C. in the example), while the phase transition temperatures of the PCM materials of the outer thermal barrier 13b range, in a second range of temperatures higher than the first one, from a second temperature (T2) to a temperature higher than said second temperature (here 45° C.), with T1=T2, within less than 5° C.

A comparable mode of operation can be provided in a vehicle 33, comprising, as an inner space 9 and as shown diagrammatically in FIG. 4, a passenger compartment of the vehicle or an adjoining storage zone, such as a boot, surrounded by a wall 11 of the aforementioned type, that is to say, with an outer thermal barrier 13b containing several PCM materials (again 15d, 15e, 15f in the example) and the inner thermal storage element 13a containing at least one PCM material (again 15a and 15c in the example), with the understanding that the constitutions of the materials with PCM elements could be different.

In the example the wall 11 is that of the roof of the cab interior 9 which borders it on one side, and so surrounds it locally.

Air conditioning means 35 provide air in the passenger compartment 9 which may be fresh to crystallize the PCM 15d and/or 15e material(s), for example air at 15-18° C. if the phase transition temperatures are respectively 16° C. and 25° C. (T1).

Means 35, such as a valve, provide a selective communication between the refrigerant, here the air, and the space 9, depending on the temperature.

The comfort temperature in the passenger compartment 9 is assumed to be within a predetermined range of 18° C. to 25° C. This range of comfort temperatures has been entered into the memory of the on-board computer 39 which controls an automated operation of the air conditioning 35, in relation with a sensor 39 of the actual temperature in the passenger compartment 9 (the latter means existed in the previous application).

The thermal storage of the inner element 13a can for example be programmed when the vehicle 33 is not being used and/or when the aforementioned air conditioning operates. And the PCM outdoor materials 15d, 15e, 15f, are supposed to crystallize after a cool night (at less than 25° C., for example 15° C.). They can have respective phase transition temperatures (between liquid and solid) of 45° C., 35° C. and 25° C., to be operative only when the outdoor temperature is hot (more than 25° C.). Thus, they can gradually liquefy when the outdoor temperature rises, and thus charge themselves with heat energy, thereby delaying the action of the thermal insulation 19 and all the more so the thermal impact on the heating of the space 9, thus limiting the operation of the air conditioning means 35. This process thus produces a passive air conditioning.

As noted above, the PCM materials of the inner heat-storage element 13a therefore have phase transition temperatures less than or equal to the temperatures in said predetermined temperature range to be maintained (here 18 to 25° C., therefore), the temperature of the fresh, conditioned, charge air being lower than those of this predetermined temperature range to be maintained.

And the phase transition temperatures of the PCMs in the same inner element 13a all range between the temperature of the charge fluid in said space 9 (here 15-18° C.) and the highest temperature in said predetermined temperature range (here 25° C.).

As for the phase transition temperatures of the PCM materials of the outer thermal barrier 13b, they will preferably be chosen to be higher than or equal to those of said inner element 13a, where once more and preferably T1=T2, within 5° C., on both sides of the insulation 19.

A comparable operating principle is found on the constructed building element 40 (FIG. 5) situated in the outdoor environment 7 (for example a south-facing facade, in a warm place, such as the south of Spain) and whose inner space 9 (for example a living room) is here again surrounded (at least partially) by a wall 11 of the aforementioned type. The inner heat-storage element 13a contains at least one PCM material (again 15a and 15c in the example) and the outer thermal barrier 13b with PCM materials 15d-15h in the example. Preferably, the PCM phase transition temperatures of the barrier 13b will range from −50° C. to 45° C., for a barrier effect in both the cold and the hot conditions, and that (those) of the PCMs of the inner element 13a will range from 15° C. to 25° C., and preferably from 15° C. to 20° C.

Thus, it is possible for the inner space 9 to tend to maintain a temperature of between 18 and 25° C. for at least several hours by heat transfer:
between the inner space 9 and the inner element 13b, and
between the outer thermal barrier 13a and the outdoor environment 7.

Given the dimensions of the walls 11 which are typically room walls, it suffices for a low natural convection in the space 9 and a gradient even limited to less than 1° C. between the temperature of this space and that at least of the phase transition of the PCM 15a for the storage in the inner element 13a to take place.

As for the fluid supplying means, here they comprise means 41, such as aeration means, doors and windows in the example, to create at least this natural convection.

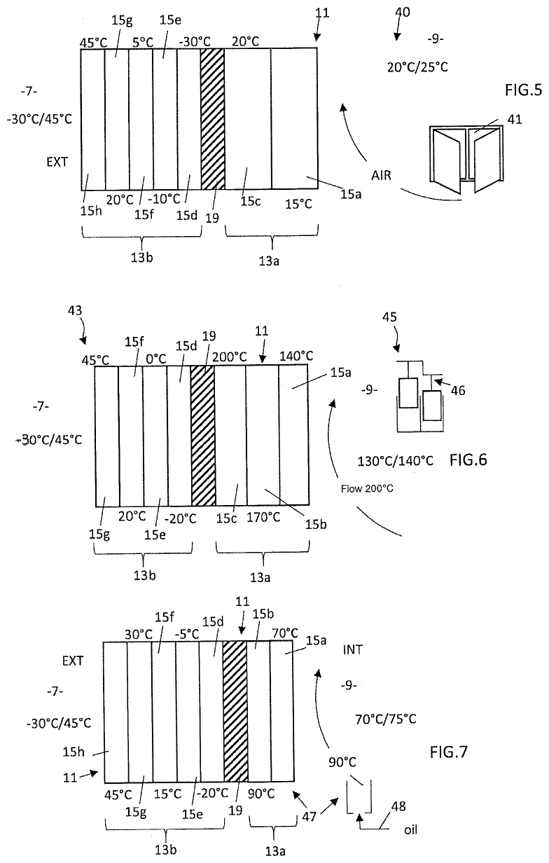

The following example of FIG. 6 shows the case of a vehicle 43 (such as a car, a train, an airplane or a ship) where the inner space 9 corresponds to an inner part of an engine 45 adapted to move the vehicle of which a wall 11 as mentioned above is at least locally provided with said thermal management device. The fluid supplying means comprise functional members 46 of the engine disposed in said inner part of an engine. They may be pistons driven by a crankshaft and disposed in or in fluid communication with the space 9. The temperature of the atmosphere in this space 9 is thus influenced by that of the functional members 46.

In this case, it is in a situation where the charge fluid, such as air and/or oil, present in this inner part of an engine, is at a temperature, for example 200° C., that is higher than that of said predetermined temperature range to be maintained, such as 130/140° C.

It may indeed be desirable for example that a portion of an engine block, such as its outer wall, be maintained at such a temperature even after turning off the engine, for example for 10 to 15 hours, to enhance hot (re)start.

Preferably, the/each phase transition temperature of the PCM material(s) of the inner element 13a will then be higher than or equal to the temperature(s) in said predetermined temperature range to be maintained, 130/140° C. example.

And, the PCM materials of this inner element also have phase transition temperatures (see FIG. 6: 140/200° C.), between liquid and solid, substantially between the lowest temperature in said predetermined temperature range (130° C.) and the temperature of the charge fluid in said inner space (200° C.). Thus, the thermal storage capacity will be optimized.

As for the PCM materials of the outer thermal barrier 13b, they have here phase transition temperatures, between −20/−50° C. and 45° C., lower than those of the PCM of the inner element 13a, since the space is that of a heat engine where the temperature always exceeds 150° C. (200° C. in the example), when the engine is running. Such a situation will a priori be atypical, especially since this temperature of 200° C. will reach the space 9 at least partly by conduction, via the thermally conductive wall, typically metallic, of the engine which will also surround the space 9, and that the wall 11 can double or replace at least one place.

The following example of FIG. 7 outlines the case of a unit 47 for storing and subsequently returning thermal energy in a vehicle. This unit 47 is intended to be placed in the open air, for example ready for the engine block. As in the previous cases, it comprises the inner space 9 surrounded by the wall 11 provided with the barrier 13b and the inner heat-storage element 13a, each with PCM material(s).

The charge fluid corresponds to the liquid of a forced liquid circulation circuit 48, such as an oil circuit, communicating with the inner space 9.

As soon as the temperature of the charge fluid (90° C. in the example) in said space 9 is higher than said predetermined temperature range to be maintained (70/75° C. in the example), the/each phase transition temperature between liquid and solid of the PCM material(s) of the inner heat-storage element 13a (70 and 90° C. in the example) is higher than or equal to said temperatures in the range.

And these different phase transition temperatures of the inner elements 15a, 15bs substantially range between the lowest temperature in said range (70° C. in the example) and the temperature of the charge fluid in the inner space 9 (90° C.) in the example).

Moreover, since externally (EXT) the wall 11 can be exposed to both hot (45° C.) and cold (−50° C.) temperatures and that the space 9 is designed to receive engine fluid (such as oil), the PCM materials of the outer thermal barrier 13b have phase transition temperatures that are not greater than those of PCM of the inner element 13a.

As in the previous application, since said temperature range to be maintained is already higher than the maximum temperature of any outdoor environment (45/50° C.), the case of the unit 47 furthermore provides that the materials PCM of the outer thermal barrier 13b should have phase transition temperatures (between −20/−50° C. and 45° C.) lower than those of the PCM of the inner element 13a: 70° C. and 90° C. in the example.

And as in all the previous cases, both the inner element 13a and the outer thermal barrier 13b each have a plurality of PCM materials having phase transition temperatures that increase from the inside to the outside.

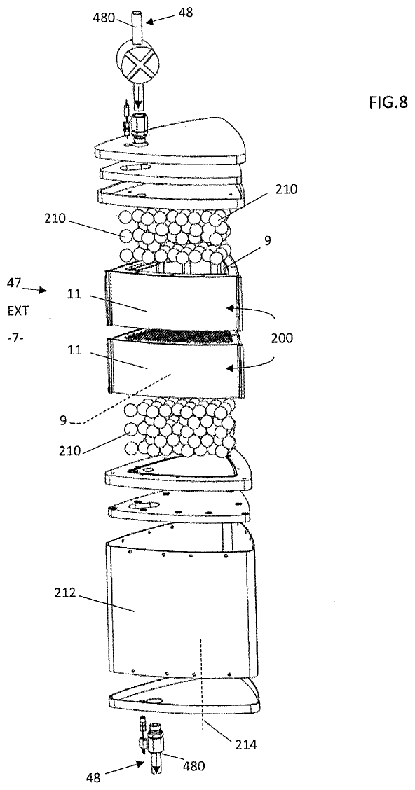

In this application with a unit 47 for storage and subsequent return of thermal energy, FIG. 8 now shows that the walls 11 can be those of boxes 200 open axially on one side (axis 214) and in each of which are disposed PCM 210 components, here in the form of spheres.

The PCM 210 components are loose and/or unorganized in the space(s) 9. These are not bars. This is not a PCM wall; these are individualized elements, each in a heat transfer situation. There is thus optimization of the residence time (RTD).

In heat transfer with the PCM components 210 and with the PCM of the inner element 13a the fluid 480 from the circuit 48, such as oil, circulates in these boxes 200 (see FIG. 7).

A sleeve 212 surrounds the boxes 200 and lids close everything axially; axis 214.

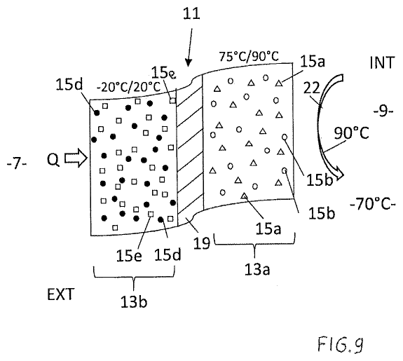

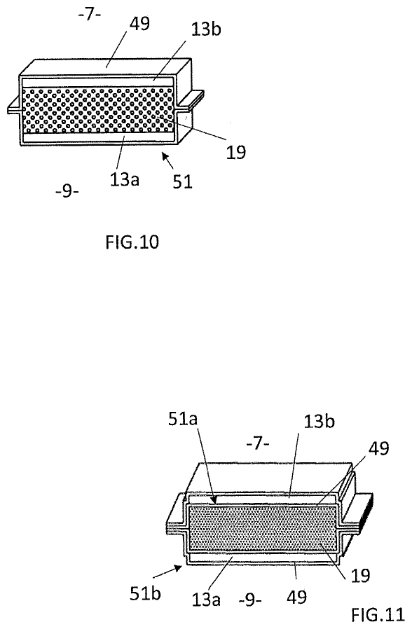

FIG. 9 is a diagram showing the use of the wall 11 provided with the barrier 13b and the inner heat-storage element 13a, each with PCM material(s), as a local protective shield, around an engine element, such as a cylinder head.

In the inner space 9, the charge fluid 22, typically oil, circulates temporarily at 80/100° C., at least at a temperature different from (here, higher than) those in said predetermined temperature ranges estimated at 70° C.

As in other cases presented here (for example in FIG. 6), the inner space 9 may be that of a separate element, separated from the wall 11, as here the engine element in question. Thus, a thermally conductive wall, such as the metallic one of this element, could be interposed between the inner element 13a of the wall 11 and the space 9. In general, the heat transfer could thus be indirect between the inner element 13a of the wall 11 and the space 9.

In the particular case of the shield mentioned above, the barrier 13b will typically aim at protecting against cold, the inner element 13a acting as a hot energy storage, a protection against the heat is not necessary since the temperature to be maintained in the space 9 is hot: estimated at about 70° C., beyond the phase of passage of the even warmer fluid 22.

It is therefore possible to choose phase transition temperatures between −20° C. and 20° C. in the barrier 13b and between 75° C. and 90° C. in the inner heat-storage element 13 a, with the thermal insulating element 19 interposed between them.

Suppose the engine has been running for several hours. It is hot. As long as the temperature in the inner space 9 remains around 70° C., the assumed operating temperature, the PCM materials of the inner element 13a are solid. Those of the barrier 13b are liquid, because of the contribution of the energy Q brought to more than 20° C. in the outdoor environment 7 by the engine operation. At the arrival of the fluid 22, towards 90° C. and a little more for example, there is storage of hot energy in the PCM materials of the inner element 13a which become liquid.

When the engine is turned off and the vehicle is parked overnight at 5° C., some (in the example) PCM materials of the barrier 13b become solid. This slows down or delays the internal cooling of the wall 11. Later, there might also be partial return of the hot energy stored in the PCM materials of the inner element 13a when at less than 90° C., some of them will become solids, thus maintaining the target temperature as long as possible and often possible in the inner space 9: 70° C., in the example.

In all the above-mentioned cases, the operating mode for the thermal management of the space 9, or the element disposed in it will be as follows:
First of all, said range of temperatures to be maintained in this space 9, or in said element as the stored element 10 of FIG. 1 will be determined;
Of course, the thermal management device with the wall 11 and its inner element 13a, outer thermal barrier 13b and thermal insulating element 19 interposed between the inner space 9 and the outdoor environment 7 will be carried out and arranged;
then, the thermal barrier 13b will be placed in heat transfer with the environment 7 and therefore its possible temperatures between −50° C. and 60° C., while the inner element 13a will be placed in heat transfer with the space 9, or with the element disposed in it;
and then, at certain times as already specified, the charge fluid will be temporarily brought into the space 9 in heat transfer with the PCM material(s) of the inner element 13a, so that it stores the thermal energy, this therefore at least at a different temperature from those in said predetermined temperature range to be maintained.

Regarding the thermal insulation 19, or even the inner element 13a and/or the outer thermal barrier 13b with PCM materials, it will be preferably disposed in a unique vacuum envelope 51 (FIG. 10) or double (FIG. 11), to define at least one vacuum insulating panel, VIP, and thus enhance the thermal efficiency of the insulation and practicality of use.

Thus, the wall 11 could be made as follows, or such a VIP panel could be integrated in a resin block or double to define this wall 11.

Each vacuum envelope 51 may be presented as an individual element or a strip comprising pockets and connecting portions. In the versions presented, the thermal insulation 19, or even the means 13a and/or 13b, are completely enclosed in one or more deformable sheets 49 of the envelope. The sheets 49, metal or plastic, are sealed together (for example welded) over the entire periphery of the casing 51, for airtightness and the desired VIP constitution. The sheet(s) measuring a few tenths of a mm to a few millimetres thick will envelop, preferably in one piece, the pockets and the connecting portions if they exist. A solution may therefore be, for the envelope 51, to produce at least a first sealed inner envelope 51a enclosing (each) a thermally insulating layer (19), the whole being, with the PCM-based layers (15a, 15d) contained in a second outer envelope 51b not necessarily sealed (FIG. 11).

Hereinafter, two examples of hot PCM and cold PCM elements, respectively, are provided for two types of batteries, for example, operating preferably between 25° C. and 35° C. and between 45° C. and 55° C. all within 15%).

It may particularly be encapsulated (typically microencapsulated) PCM in a porous matrix, with open pores, preferably of elastomer type, such as silicone, NBR or HNBR.

As the constitution of one and/or the other of the element and barrier, 13b, provision may be made for example for rubber composition as described in EP2690137 or in EP2690141, namely in the second case a crosslinked composition based on at least one vulcanized “STR” silicone elastomer at room temperature and comprising at least one PCM material, said at least one silicone elastomer that has a viscosity measured at 23° C. according to ISO 3219 which is less than or equal to 5000 mPa·s. In this case, the elastomer matrix will be predominantly constituted (i.e. based on an amount greater than 50 phr, preferably greater than 75 phr) of one or more “STR” silicone elastomers. The thermal PCM material may consist of n-hexadecane, eicosane or a calcium salt, all having melting points below 40° C.

The other element 13b or 13a may be based on paraffin, eutectic fatty acid (myristic-capric) or hydrated salt eutectic (calcium chloride+potassium).

Other possibilities exist, such as a PCM impregnated in a porous network.

Note however that any PCM may have a change of phase or state at a predetermined temperature peak or which is established over a more or less wide temperature range. Thus, with a pure PCM (such as a paraffin) the phase transition temperature will be constant, while it may be non-constant with several PCMs, such as for a mixture of paraffins.

In general, the two cases that can be encountered in the present application in connection with the PCM(s) provided, any phase transition PCM temperature here will need to be considered in a range of 10° C., and typically to +/−5° C.

1. An assembly comprising a thermal management device for enhancing, in an inner space and/or vis-à-vis an element disposed therein, while a temperature within a predetermined range is maintained, said assembly comprising:
said inner space,
said device arranged around the inner space and placed in an outdoor environment exposed to a non-constant temperature, the device comprising at least one thermal insulating element and, from inside, where said inner space is located and/or the element arranged therein, towards outside where said outdoor environment is located:
an inner heat-storage element containing at least one PCM material having a phase transition temperature between liquid and solid, which is different from temperatures included in said predetermined temperature range and/or substantially equal to the temperature of a charge fluid,
and an outer thermal barrier containing at least one PCM material which stores or releases thermal energy by phase transitions between liquid and solid, and which has at least a phase transition temperature of between −50° C. and 60° C., in order to brake, by phase transitions, the thermal action of the outdoor environment,
and fluid supplying means for temporarily supplying said charge fluid, in said inner space at least at a temperature different from temperatures in said predetermined temperature range, in heat transfer with said at least PCM material of the inner heat-storage element such that it the PCM material stores thermal energy,
the thermal insulating element being interposed between the thermal barrier and the inner heat-storage element.

2. The assembly according to claim 1, wherein said phase transition temperature of the PCM material(s) of the inner element of thermal storage is:
either higher than the temperatures in said predetermined temperature range to be maintained, if the temperature of the charge fluid in said inner space is higher than said predetermined temperature range to be maintained,
or lower than the temperatures in said predetermined temperature range to be maintained, if the temperature of the charge fluid in said inner space is lower than said predetermined temperature range to be maintained.

3. The assembly according to claim 1, wherein the inner heat-storage element and/or the outer thermal barrier contains several of said PCM materials having different phase transition temperatures, between liquid and solid.

4. The assembly according to claim 1, wherein said inner heat-storage element contains several PCM materials:
having different phase transition temperatures, between liquid and solid, ranging substantially between the temperature of the charge fluid in said inner space and the highest temperature in said predetermined temperature range, if the temperature of the charge fluid in said inner space is less than said predetermined temperature range to be maintained;
or having different liquid and solid phase transition temperatures ranging substantially between the lowest temperature in said predetermined temperature range and the temperature of the charge fluid in said inner space, if the temperature of the charge fluid in said inner space is higher than said predetermined temperature range to be maintained.

5. The assembly according to claim 1, in which:
said inner heat-storage element contains a plurality of PCM materials having different phase transition temperatures, between liquid and solid between substantially the temperature of the charge fluid in said inner space and the highest temperature in said predetermined temperature range, if the temperature of the charge fluid in said inner space is lower than said predetermined temperature range to be maintained,
the outer thermal barrier contains a plurality of PCM materials having phase transition temperatures higher than or equal to that of the PCM materials of said inner heat-storage element.

6. The assembly according to claim 1, in which:
said inner heat-storage element contain a plurality of PCM materials having different phase transition temperatures, ranging, within a first temperature range which is relatively low, between a low temperature and a first higher temperature;
and the outer thermal barrier contains a plurality of PCM materials having different phase transition temperatures, ranging, within a second temperature range higher than the first temperature range, between a second temperature and a higher temperature;
and said first and second temperatures are identical, at nearly 5° C.

7. The assembly according to claim 1, wherein at least one of the inner heat-storage element and outer thermal barrier comprises several layers of materials each containing a PCM material, said PCM materials having phase transition temperatures different from each other.

8. The assembly according to claim 1, wherein at least one of the inner heat-storage element and outer thermal barrier comprises a plurality of PCM materials having different phase transition temperatures dispersed in a matrix.

9. The assembly according to claim 1, for cold preservation, wherein the fluid supplying means comprise a cooling unit.

10. A vehicle comprising said assembly according to claim 1, wherein:
the inner space comprises a passenger compartment of the vehicle or an adjoining storage zone of the vehicle,
and the fluid supplying means comprise air conditioning means from which said fluid flows.

11. Part of a constructed building, located in an outdoor environment comprising said assembly according to claim 1, and wherein:
at least one room corresponds to said inner space, surrounded by a wall provided with said thermal management device, and
the fluid supplying means comprise means, such as aeration means, like doors and windows, to create at least one natural convection in said inner space in contact with the inner heat-storage element.

12. A unit for storing and subsequently releasing thermal energy, on an on-board system, said unit comprising the assembly according to claim 1, wherein the charge fluid corresponds to the liquid of a forced liquid circulation circuit such as an oil circuit, communicating with said inner space.

13. A vehicle comprising said assembly according to claim 1, wherein:
the inner space corresponds to an inner part of an engine adapted to move the vehicle of which a wall is at least locally provided with said thermal management device, and
the fluid supplying means comprise functional members of an engine disposed in said inner portion of an engine, such as pistons or a crankshaft.

14. A method of thermal management of an inner space, or an element disposed in said inner space, surrounded by a thermal management device, wherein:
a predetermined temperature range of the inner space, or of the element disposed therein, to be maintained is determined,
the thermal management device is made and disposed with at least one thermal insulating element and, from the inside, where said inner space and/or the element which is disposed therein, is located towards the outside:
an inner heat-storage element containing at least one PCM material having a phase transition temperature between liquid and solid, which is different from those included in said predetermined temperature range and/or substantially equal to that of a charge fluid,
and an outer thermal barrier containing at least one PCM material that storing or transferring thermal energy by phase transitions between liquid and solid, and having at least a phase transition temperature of between −50° C. C and 50° C., for braking, by phase transitions, the thermal action of the outdoor environment, the thermal insulating element being interposed between the thermal barrier and the inner heat-storage element, the outer thermal barrier of the device is placed in heat transfer with said outdoor environment having a temperature of between −50° C. and 60° C., and the PCM material(s) is/are then left to store or return thermal energy depending on said temperature, and in heat transfer, said at least one PCM material of the inner heat-storage element is placed with the inner space, or with the element disposed inside,
and, at certain times, said charge fluid is temporarily brought into said inner space at least at a temperature different from that in said predetermined temperature range, in heat transfer with said at least one PCM material, such that it then stores thermal energy.
